(19) United States
(12) Patent Application Publication
(10) Pub. No.: US 2015/0254064 A1
(43) Pub. Date: Sep. 10, 2015

(54) Method and a Technical Equipment for Social Network Service

(71) Applicants: Wenwen Han, (US); Ye Tian, (US); Wendong Wang, (US); Jian Ma, (US); Nokia Technologies Oy, Espoo (FI)

(72) Inventors: Wenwen Han, Beijing (CN); Ye Tian, Beijing (CN); Wendong Wang, Beijing (CN); Jian Ma, Beijing (CN)

(21) Appl. No.: 14/430,682

(22) PCT Filed: Oct. 26, 2012
(86) PCT No.: PCT/CN2012/083553

§ 371 Date: Mar. 24, 2015

(51) Int. Cl. G06F 7/32; G06Q 50/00; G06F 17/30

(52) U.S. Cl. CPC G06F 7/32; G06F 17/3053; G06F 17/30867; G06Q 50/01

(57) ABSTRACT

The embodiments of the invention relates to a method and a technical equipment for social network. The method comprises determining a relation degree between a user and a connection for each user relation at a specific time; listing the determined relations in time order to create a time-serial relation sequence; repeating the previous steps for all connections of the user; and grouping the connections according to the created time serial relation sequences.

### TECHNICAL FIELD

The present solution relates to a social network service, and in particular to determine a relation between a user and a connection.

### BACKGROUND

Social network services (SNS) such as Facebook, LinkedIn, and Twitter etc. provide enormous opportunities for people to get to know new friends and maintain contact with old friends. Users in those online social network platforms are associated with each other by plenty of relations, including: follower-followee relation, ask-reply relation, sharing common friends relation, having similar background relation, sharing common interested content relation etc. Those relations help SNS providers to better understand how users relate to one another and how they behave in their social circles. Using those relations, the users can be categorized into several groups, such as “my friend” group, “my frequent-contact” group, “my common-interest” group etc. Nowadays, it becomes a routine work of SNS service providers to estimate user relations and investigate user groups, aiming to develop accurate recommendation service, customized functionalities and decision supports.

### SUMMARY

Now there has been invented an improved method and technical equipment implementing the method, by which user grouping in social network services is made by using time-serial user relation. Various aspects of the invention include a method, an apparatus, a system and a computer readable medium comprising a computer program stored therein, which are characterized by what is stated in the independent claims. Various embodiments of the invention are disclosed in the dependent claims.

According to a first aspect, a method comprises determining a relation degree between a user and a connection for each user relation at a specific time; listing the determined relations in time order to create a time-serial relation sequence; repeating the previous steps for all connections of the user; and grouping the connections according to the created time serial relation sequences.

According to a second aspect, an apparatus comprises at least one processor, memory including computer program code, the memory and the computer program code configured to, with the at least one processor, cause the apparatus to perform at least the following: determine a relation degree between a user and a connection for each user relation at a specific time; list the determined relations in time order to create a time-serial relation sequence; repeat the previous steps for all connections of the user; and group the connections according to the created time serial relation sequences.

According to a third aspect, a system comprises at least one processor, memory including computer program code, the memory and the computer program code configured to, with the at least one processor, cause the system to perform at least the following: determine a relation degree between a user and a connection for each user relation at a specific time; list the determined relations in time order to create a time-serial relation sequence; repeat the previous steps for all connections of the user; and group the connections according to the created time serial relation sequences.

According to a fourth aspect, an apparatus comprises at least: means for determining a relation degree between a user and each connection of the user for each user relation at a specific time; means for listing the determined relations in time order to create a time-serial relation sequence; means for grouping the connections according to the created time serial relation sequences.

According to a fifth aspect, a computer program product embodied on a non-transitory computer readable medium, comprising computer program code configured to, when executed on at least one processor, cause an apparatus or a system to: determine a relation degree between a user and a connection for each user relation at a specific time; list the determined relations in time order to create a time-serial relation sequence; repeat the previous steps for all connections of the user; and group the connections according to the created time serial relation sequences.

According to an embodiment, the groups are displayed to the user.

According to an embodiment, the connections with similar time serial relation sequence are grouped into a same group.

According to an embodiment, information to a user and to a group is transmitted on the basis of the group, which information relates at least one of the following: recommendation, suggestion, promotion.

According to an embodiment, the user relation is one or more of the following: mutual friends of the user and the connection; common viewed topics; co-attended activities; common background; interactions.

According to an embodiment, for determining a relation degree between a user and a connection for each user relation at a specific time context information of the user is collected; the context information of the user is related to a context information of the connection to determine a numerical context value; and the context values are merged at a certain time to obtain a relation degree for the certain time.

According to an embodiment, at least one piece of context information is weighed.

According to an embodiment, the context information comprises one or more of the following pieces: a friend list, education background, interests, posts in online platform, login logs, click logs.

### DESCRIPTION OF THE DRAWINGS

In the following, various embodiments of the invention will be described in more detail with reference to the appended drawings, in which

FIG. 1 shows a system according to an embodiment;

FIG. 2 shows a block diagram of an apparatus according to an embodiment;

FIG. 3 shows an example of a layout of an apparatus according to an embodiment;

FIG. 4 shows an example of a server according to an embodiment;

FIG. 5 shows an example of a user relevance degree sequence for a time period;

FIG. 6 shows an example of user relevance measurement for a certain time;

FIG. 7 shows an example of a representation of time-serial user relations;

FIG. 8 shows an example of grouping users;

FIG. 9 shows an example of a user interface view for displaying groups; and

FIG. 10 shows a flowchart according to an embodiment of a method.

### DESCRIPTION OF EXAMPLE EMBODIMENTS

In the following, several embodiments of the invention will be described in the context of social network service. It is to be noted, however, that the different embodiments of the invention may have applications in any other environment.

Social network(ing) service (SNS) is a term to describe a service, a platform or a site that enables generating social links or social relationships among people. According to an embodiment, a person has a user profile in the social network service, which user profile can be linked to other user profiles to create a social network. The social network provides means to interact over the Internet, e.g. by emailing and/or by chatting (i.e. instant messages). The social network also provide means to share data, such as web pages, news, media to all or selected linked user profiles. Examples of social networks of today are Facebook, LinkedIn, Twitter, Google+. In the context of social network term “relation” is used to describe the way two users are related to each other. Examples of relations are common friends, shared background, interactions etc. In this disclosure, term “relation” is used for the same purpose. In the following description term “user” refers to a person used as an example for the embodiments and who has a profile in the social network service. The profile is linked to profiles of other users, which other users are referred with “connections” in the following description.

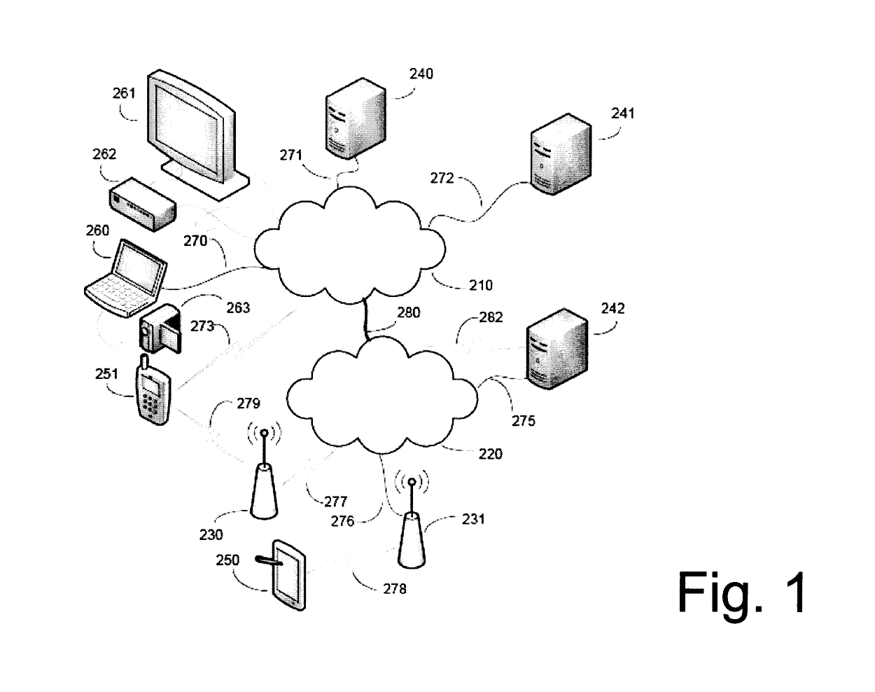

FIG. 1 shows a system and devices according to an embodiment. In FIG. 1, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 1 are shown servers 240, 241 and 242, each connected to the mobile network 220, which servers, or one of the servers, may be arranged to operate as computing nodes (i.e. to form a cluster of computing nodes or a so-called server farm) for a social networking service. Some of the above devices, for example the computers 240, 241, 242 may be such that they are arranged to make up a connection to the Internet with the communication elements residing in the fixed network 210.

There are also a number of end-user devices such as mobile phones and smart phones 251, Internet access devices (Internet tablets) 250, personal computers 260 of various sizes and formats, and computing devices 261, 262 of various sizes and formats. These devices 250, 251, 260, 261, 262 and 263 can also be made of multiple parts. In this example, the various devices are connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection. All or some of these devices 250, 251, 260, 261, 262 and 263 are configured to access a server 240, 241, 242 and a social network service.

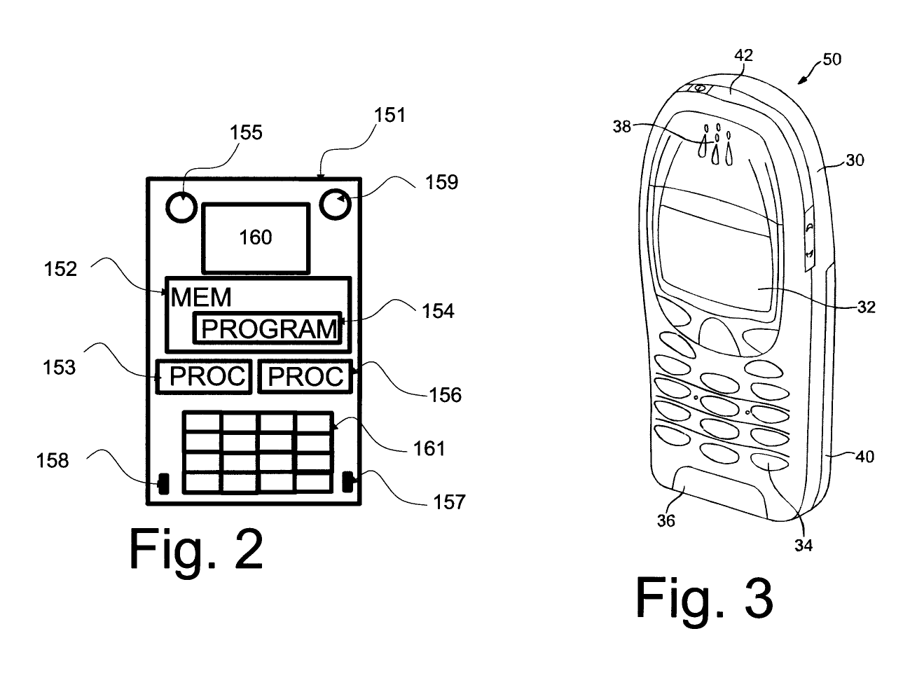

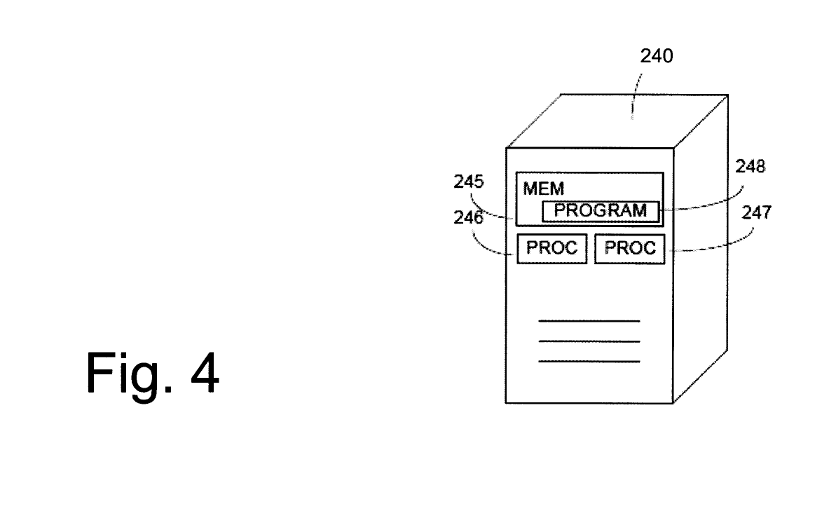

FIGS. 2-4 show devices by means of which social network is created according to an embodiment. As shown in FIG. 4, the server 240 contains memory 245, one or more processors 246, 247, and computer program code 248 residing in the memory 245 for implementing, for example, social network service. The different servers 241, 242 of FIG. 1 may contain at least these elements for employing functionality relevant to each server.

Similarly, the apparatus 151 shown in FIG. 2 contains memory 152, at least one processor 153 and 156, and computer program code 154 residing in the memory 152. The apparatus according to the example of FIG. 2, also has one or more cameras 155 and 159 for capturing image data, for example stereo video. The apparatus of this example also contains one, two or more microphones 157 and 158 for capturing sound. The apparatus may also contain sensor for generating sensor data relating to the apparatus' relationship to the surroundings. The apparatus also comprises a display 160 for viewing single-view, stereoscopic (2-view) or multiview (more-than-2-view) images. The display 160 may be extended at least partly on the back cover of the apparatus. The apparatus 151 also comprises an interface means (e.g. a user interface) which allows a user to interact with the apparatus. The user interface means is implemented either using one or more of the following: the display 160, a keypad 161, voice control, or other structures. The apparatus is configured to connect to another device e.g. by means of a communication block (not shown in FIG. 2) able to receive and/or transmit information. The apparatus is configured to access a social network service in a server via the communication block.

FIG. 3 shows a layout of an apparatus according to an example embodiment. The electronic device 50 is for example a mobile terminal (e.g. mobile phone, a smart phone, a camera device, a tablet device) or user equipment of a wireless communication system. However, it would be appreciated that embodiments of the invention may be implemented within any electronic device or apparatus, such a personal computer and a laptop computer, which are capable of connecting Internet and to a service residing in the internet.

The apparatus 50 shown in FIG. 3 comprises a housing 30 for incorporating and protecting the device. The apparatus 50 further comprises a display 32 in the form of e.g. a liquid crystal display. In other embodiments of the invention the display is any suitable display technology suitable to display an image or video. The apparatus 50 further comprises a keypad 34 or other data input means. In other embodiments of the invention any suitable data or user interface mechanism may be employed. For example the user interface may be implemented as a virtual keyboard or data entry system as part of a touch-sensitive display. The apparatus comprises a microphone 36 or any suitable audio input which may be a digital or analogue signal input. The apparatus 50 further comprises an audio output device which in embodiments of the invention may be any one of: an earpiece 38, speaker, or an analogue audio or digital audio output connection. The apparatus 50 of FIG. 3 also comprises a battery 40 (or in other embodiments of the invention the device may be powered by any suitable mobile energy device such as solar cell, fuel cell or clockwork generator). The apparatus according to an embodiment comprises an infrared port 42 for short range line of sight communication to other devices. In other embodiments the apparatus 50 may further comprise any suitable short range communication solution such as for example a Bluetooth wireless connection or a USB/firewire wired connection. The apparatus 50 according to an embodiment also comprises one or more camera capable of recording or detecting individual image frames.

The social network service resides on a server, or more than one servers that implements the social network service in cooperation. The SNS service providers carries out different functions for the social network service in order to improve the uses experience but also to improve efficiency. One of the functions is to estimate user relations (i.e. how a user and a connection are related) and investigate user groups. This enables developing accurate recommendation service, customized functionalities and decision supports.

The idea of user grouping is to measure the relation degree among members in the group. In an example the relation degree between two users (i.e. a user and a connection) is determined in one or more of the following ways: the total count of common friends, the total count of reply interactions, overlap of interested topic keywords and attending the same activity etc.

According to an embodiment, the relation degree is determined as a merge score of the individual measures. Regardless of the estimation methods, the relation degree between the user and the connection is represented as a comparable single numerical value in solutions of related art. User pair (Le. a user and a connection) with larger relation degree is considered to be more close to each other than other user pairs. Closer users are categorized into the same group, while users with lesser relation degree are divided into different groups.

By means of the user group information, SNS service providers are able to design different schema for smart services. For example, if two users have high common interests relation, SNS service provider can recommend an activity of one of the users to the other, or a viewed topic of one of the user to the other, which will be desired by the other user also. Also, if two users have high interaction relation or friend relation, SNS service provider can push shopping suggestions or questionnaire result to both of the users to assist in decision making.

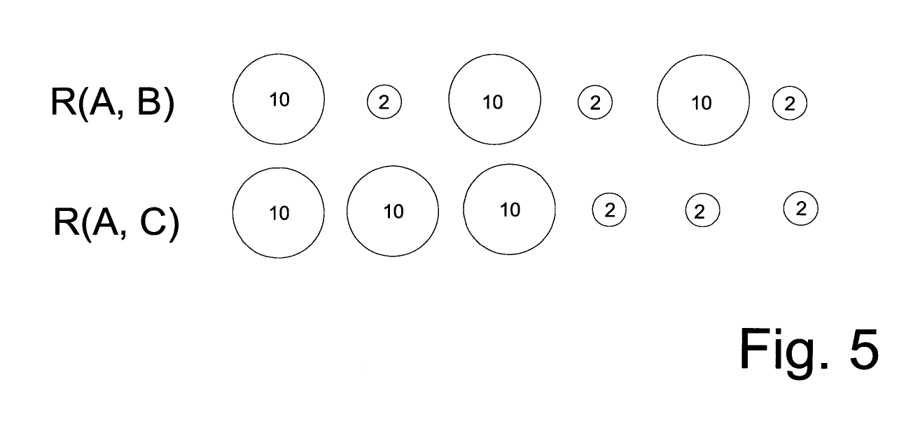

The basic idea of grouping user is to find ways to compute the relation degree between two users (i.e. a user and a connection), and group connections with high relation to the user into the same group and connections with low relation to the user into different groups. Now it has been noticed that the relation degree between users is actually a time-serial vector rather than a single numerical value (i.e. relation score). And therefore user relations are not the same when the time-serial vectors are different. FIG. 5 clarifies this. In FIG. 5, there is a user A that has social network with connections B and C. In order to understand the relationship (A, B) between the user A and the connection B; and the relationship (A, C) between the user A and the connection C, their interaction frequencies are measured. Assume that there are {10,2,10,2,10,2} relations between (A, B) in the last 6 months, and there are {10,10,10,2,2,2} relations between (A, C) in the same time period. In this example, each of the numbers within brackets { } represents the amount of monthly interactions between the user and the connection. Without taking time factor into consideration, the total relation degree between (A, B) and (A, C) are completely the same, that is 36 (which is 10+10+10+2+2+2). However, as will be shown, this does not mean that (A,B) and (A,C) has same kind of user relation. When the relation degree is listed in time-serial order, as shown in FIG. 5, the two sequences are quite different. For example, user A and connection B are co-workers in a same bi-monthly project and have to contact frequently every two months. User A and connection C, on the other hand, have been close friends for the first three months, but quarreled with each other in the following three months. Therefore, the user A and the connection C are not willing to contact with each other as frequently as before. It is thus realized that time-serial user interactions may reveal different user relation states.

On such circumstance, if the two relations are considered as the same, and the same recommendation schema is used to push information for these two pairs, (A, B) may glad to receive the information, while (A, C) may be annoyed by the recommendations. Therefore, only estimating single score to represent user-connection relation may cause misunderstanding or inadequate understanding of user-connection relations, which will bring bad effect on the corresponding recommendation services and business intelligence services.

In order to get better understanding of user relation, the present embodiments propose solutions to measure user relation to each connection in time-serial aspect, and group the connections on basis of the relation. This deviates from the methods of related art where only single numerical relation value is determined. The present embodiments are able solve the problem of single numerical value's inability to represent relations changing with time, because it brings time context into user-connection relation measurement. Thus, when the relations between the user and the connection are measured, the relation between the sequences is measured; when two relation pairs are compared, the difference between the relation lists is compared, but not the relation values.

The embodiments use sequence data structure to model user relation. The entries in the sequence are listed in time order, and represent the relation between a user and a connection at a certain time. The embodiments use list relation estimation methods to compare the user-connection relations, rather than compare the single values. The embodiments group the connections by using time-serial user-connection relations.

In the following description, “X” refers to a user X, “Y” refers to a connection Y, “Z” refers to a connection Z, “t” refers to a certain time instant, “Rt(X, Y)” refers user relation relevance degree between the user X and the connection Y at time instant “t”. Rp(X, Y) refers to time-serial relation sequence between the user X and the connection Y in a period of time “p”. G(X) refers to a group containing the user X which is a set of user-connection pair.

The steps for carrying out an embodiment comprises 1) estimating user relation to a connection at a specific time; 2) representing time-serial user relation to said connections; 3) repeating steps 1) and 2) for all connections of the user; 4) grouping connections using time-serial relation; 5) displaying groups (and recommendations). In another embodiment, the groups are not necessarily displayed to the user, whereby the step 5) can be omitted.

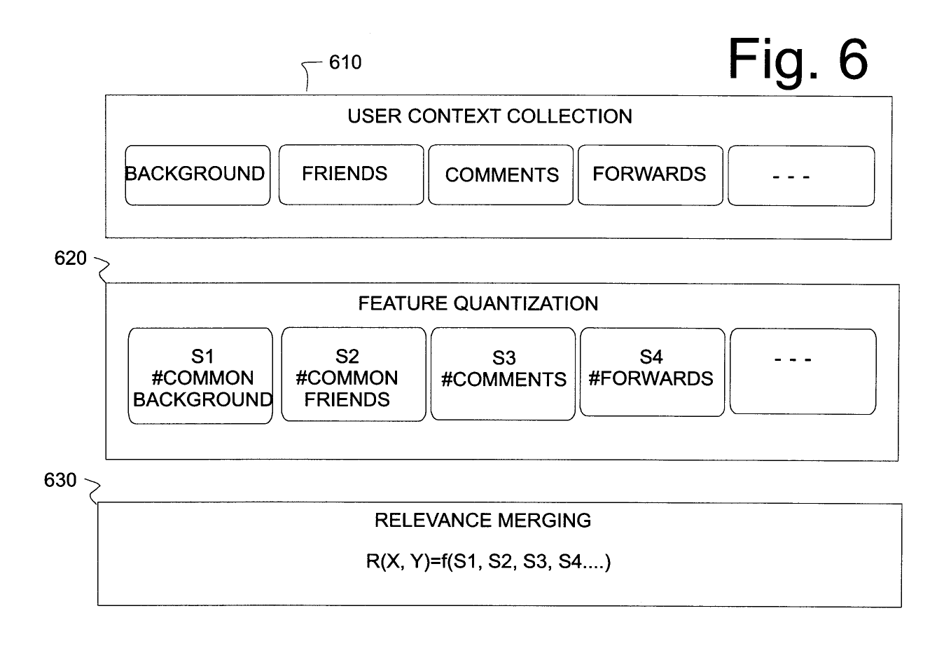

According to an embodiment, for estimating user-connection relation at a specific time, the relation is measured by adopting the traditional ways, such as counting the mutual friends of the user and the connection, counting the common viewed topics, counting the co-attended activities etc., resulting in a single numerical value. For example, at a certain time t, the relation between the user and the connection is measured as shown in FIG. 6. At first user context information is collected (610). According to an embodiment, the user context information includes one or more of the following: friend list, education background, interests, posts in online platform, login logs, click logs etc. The user context information represents the characteristics of the user, and is used to measure common points or interactions between the user and the connections. Next step is a feature quantization (620), where relation degree corresponding to each context features are determined between the user and the connection, and the relation is represented as a numerical value.

For example, if the user X and the connection Y have been in the same university, in the same high school and in the same junior school, their background context information may be represented as the total count of background overlaps, that is S1=3. As another example the user X has given the connection Y 100 comments on the connection Y's homepage or electronic wall. In such a case their comment context information is quantified as a numerical value S3=100. After having the context values, the next step is to perform relation merging (630). The separated context values (S1, S2, S3, S4, . . . ) are merged at time t into a single numerical relation degree Rt(X, Y). This degree represents the relation between the user X and the connection Y at time t. In computation, Rt(X, Y) is a function with context quantization scores as input parameters. According to an embodiment, the features are considered linear related, and Rt(X, Y) is computed with the formula Rt(X, Y)=(S1, S2, S3, S4, . . . )=Σwᵢ*sᵢ, where wᵢ represents the weight of feature and sᵢ represents the quantization value of feature i. wᵢ is given by artificial annotation or machine learning approaches. It is determined from the business point of view, how important a certain features is. Therefore, the more important the feature is, the larger weight will be assigned to it.

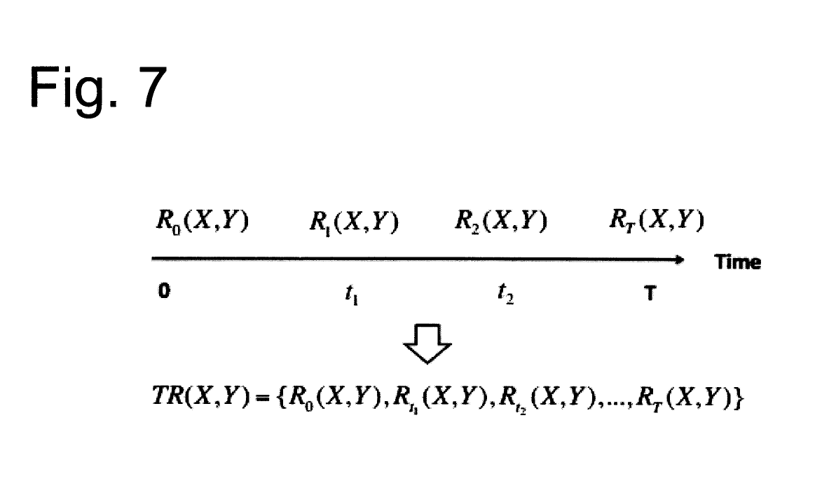

For representing time-serial user relation, the user relations for a period of time are gathered and the relations are listed in time order forming the time-serial vector. Each entry in the time-serial vector represents the relation degree at a specific time. Two relations are regarded different even if a single entry in the vector is different. According to an embodiment, this is implemented by executing multiple times the operation for estimating user relation at a specific time, described previously, to get the time-serial relations during a certain period of time P. Time-serial relation sequence between the user X and the connection Y is denoted by Rp(X, Y). This has been illustrated in FIG. 7. The relation degree estimation process is carried out at a sequence of specific time. The relation score is R0(X, Y) for time 0, R1(X, Y) for time t1, R2(X, Y) for time t2, and RT(X, Y) for time T. These values form a sequence Rp(X, Y), which represent the relevance changes between the user X and the connection Y over time.

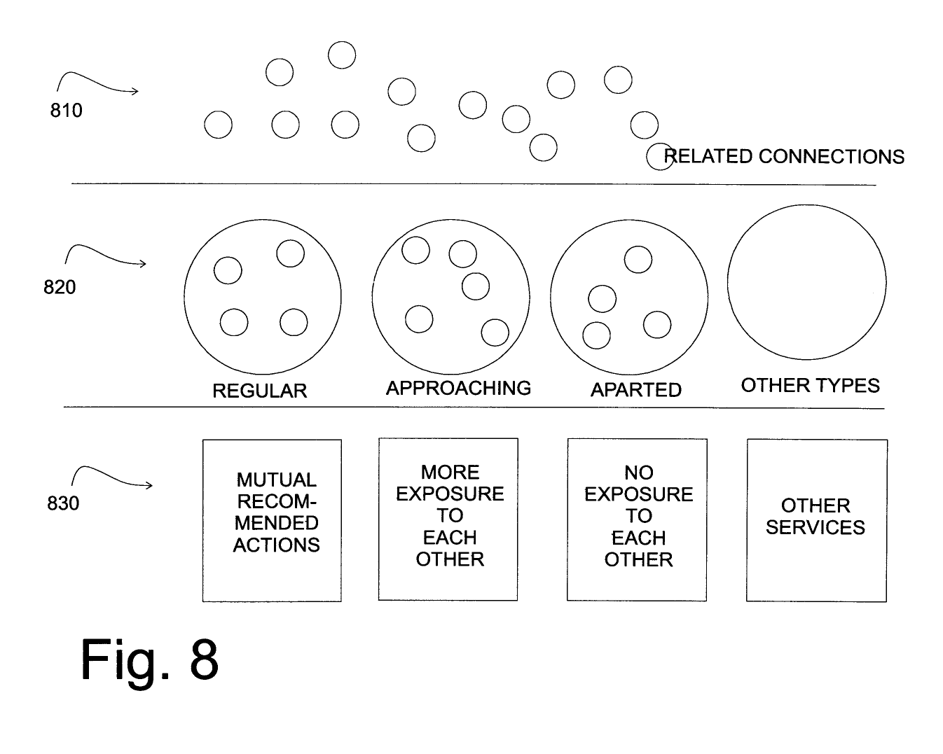

For grouping users by using time-serial user relations, in an embodiment user relation similarity is determined by using sequence correlance approach, rather than comparing the values of similarities. Connections with similar user-connection relations to the user are categorized into the same groups, while connections with unsimilar user-connection relations are separated into different groups. FIG. 8 illustrates the user relation grouping process, where related connections are determined (810), whereby connections with similar user relations are grouped (820) into a same group. In the example of FIG. 8, the groups are regular (constant relations during time sequence), approaching (more relations at the end of the time sequence), aparted (more relations at the beginning of the time sequence) and other types (rest of the connections, not falling into any previous group. In order to group the connections into groups, such as group {(X, Y), (X, Z), . . . } and group {(Y, Z), . . . }, multi-dimension K-Mean clustering algorithms is used according to an embodiment. Within a group, user relation between each user-connection pair are similar to other user-connection pairs, which means that the relation between the user X and the connection Y is very similar to the relation between the user X and the connection Z. But the relation between the user Y and the connection Z are different from the relations in {(X Y), (X Z) . . . }. The recommendation schema is created based on the user groups (830). In the example of FIG. 8, users in the regular group are given mutual recommendations; users in the approaching group are given more exposure to each other; users in the aparted group are given no exposure; and users in the other type of group are given other services.

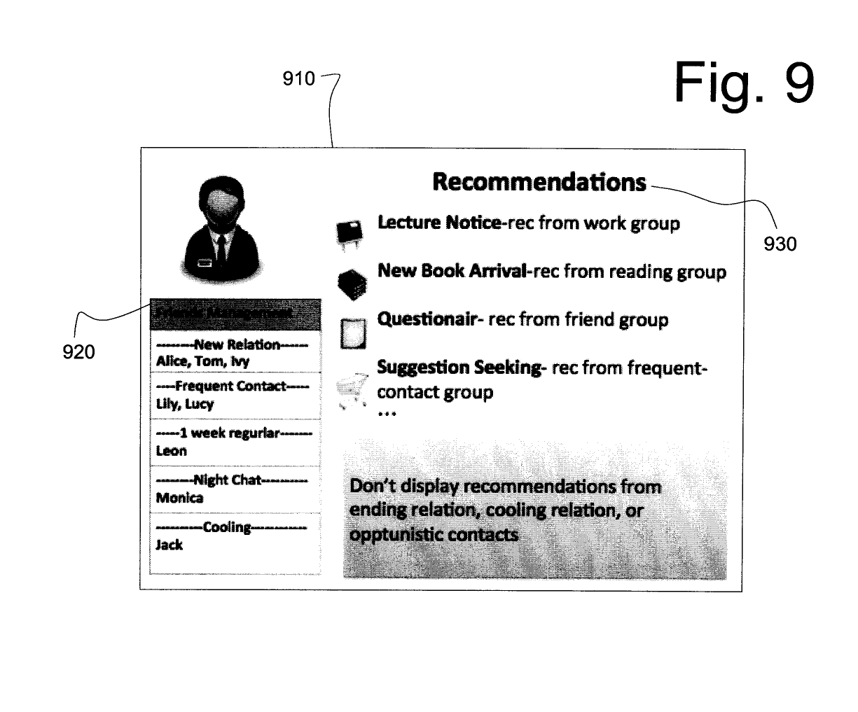

Finally the grouping results may be displayed to the user to facilitate user's friends management, and make recommendations on basis of the groups. User relations in the same groups are similar to each other, and therefore similar recommendation schema is designed within the same group. Concerning a certain user, user's relations may be separated into several groups. Within each group, members have similar relations, such as starting a new friendship relation or maintain stable relation or opportunistic contact with each other or part in an old relation. The grouping result can be displayed to users to facilitate user's friends management, and users are able to annotate each group with a tag to present its social meaning. FIG. 9 illustrates displaying groups for a certain user. The user interface view (910) comprises regions for friends management (920) and recommendations (930). For different kinds of relations, SNS service providers may design different recommendations or promotion strategies. For example, group {(X, Y), (X, Z), . . . } represents starting a new relation group, whereby each pair in the group can be given more exposure by recommending each other as candidate friends, or recommend each other as candidate friends, or recommend each other's new updates, or list each other's suggestions under the same situation etc. On the contrary, group {(Y, Z), . . . } represents an ending relation, whereby exposures to each pair in such groups are reduced to avoid users annoys.

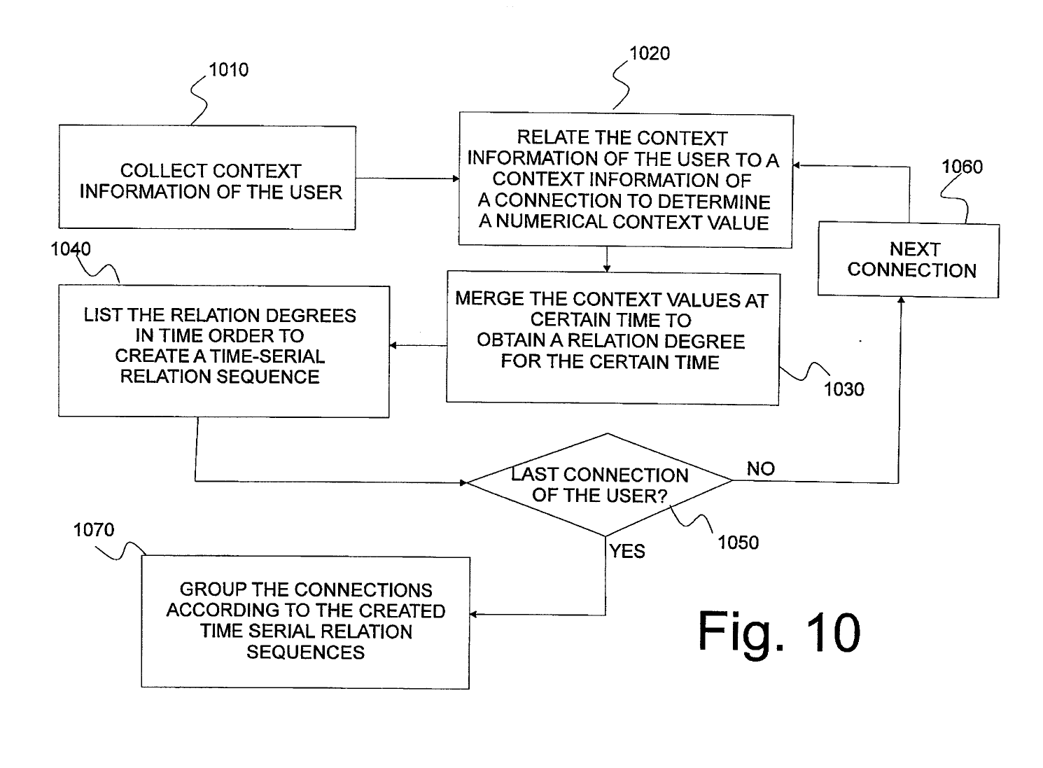

FIG. 10 summarizes an embodiment of the method. This embodiment comprises collecting context information of the user (1010); relating the context information of the user to a context information of a connection to determine a numerical context value (1020); merging the context values at certain time to obtain a relation degree for the certain time (1030); listing the relation degrees in time order to create time-serial relation sequence (1040); determining whether the connections was the last connection of the user (1050); and if no, taking the next connection (1060) and repeating steps 1020-1050; if yes, grouping the connections according to the created time serial relation sequences (1070).

The various embodiments may provide advantages. For example, time context information is brought into user relation modeling, and users are grouped by using time-serial relations. Further the grouping result is displayed for friends management and/or customized recommendation schema is designed according the grouping result. All these make it possible to get more adequate understanding of user relations and user behaviors, which as a result provide more evidence for more accurate recommendations, decision support, result rankings and customized user experience designs, and also user relation predictions and user relation trends predictions.

The various embodiments of the invention can be implemented with the help of computer program code that resides in a memory and causes the relevant apparatuses to carry out the invention. For example, a device comprises circuitry and electronics for handling, receiving and transmitting data, computer program code in a memory, and a processor that, when running the computer program code, causes the device to carry out the features of an embodiment. Yet further, a network device like a server comprises circuitry and electronics for handling, receiving and transmitting data, computer program code in a memory, and a processor that, when running the computer program code, causes the network device to carry out the features of an embodiment. In the previous description, it is realized that the social network service resides in one or more servers, and an apparatus is connected to the server to have the access to the social network service. The time-serial user relation determination may be carried out at the server, but in some embodiments, some or all of needed operations may be carried in the apparatus.

It is obvious that the present invention is not limited solely to the above-presented embodiments, but it can be modified within the scope of the appended claims.

1-33. (canceled)

34. A method, comprising:
a) determining a relation degree between a user and a connection for each user relation at a specific time;
b) listing the determined relations in time order to create a time-serial relation sequence;
c) repeating steps for all connections of the user; and
d) grouping the connections according to the created time serial relation sequences.

35. The method of claim 34, further comprising:
displaying the groups to the user.

36. The method of claim 34, wherein the step d) further comprises
grouping the connections with similar time serial relation sequence into a same group.

37. The method of claim 34, further comprising:
transmitting information to a user and to a group on the basis of the group, which information relates at least one of the following: recommendation, suggestion, promotion.

38. The method of claim 34, wherein the user relation is one or more of the following: mutual friends of the user and the connection; common viewed topics; co-attended activities; common background; interactions.

39. The method of claim 34, wherein step a) comprises
collecting context information of the user;
relating the context information of the user to a context information of the connection to determine a numerical context value; and
merging the context values at a certain time to obtain a relation degree for the certain time.

40. The method of claim 39, further comprising
weighing at least one piece of context information.

41. The method of claim 39, wherein the context information comprises one or more of the following pieces: a friend list, education background, interests, posts in online platform, login logs, click logs.

42. An apparatus comprising at least one processor, memory including computer program code, the memory and the computer program code configured to, with the at least one processor, cause the apparatus to perform at least the following:
a) determine a relation degree between a user and a connection for each user relation at a specific time;
b) list the determined relations in time order to create a time-serial relation sequence;
c) repeat steps a) and b) for all connections of the user;
d) group the connections according to the created time serial relation sequences.

43. The apparatus of claim 42, further comprising computer program code configured to, with the processor, cause the apparatus to perform at least the following:
display the groups to the user.

44. The apparatus of claim 42, further comprising computer program code configured to, with the processor, cause the apparatus to perform at least the following:
group the connections with similar time serial relation sequence into a same group.

45. The apparatus of claim 42, further comprising computer program code configured to, with the processor, cause the apparatus to perform at least the following:
transmit information to a user and to a group on the basis of the group, which information relates at least one of the following: recommendation, suggestion, promotion.

46. The apparatus of claim 42. wherein the user relation is one or more of the following:
mutual friends of the user and the connection; common viewed topics; co-attended activities; common background; interactions.

47. The apparatus of claim 42, further comprising computer program code configured to, with the processor, cause the apparatus to perform at least the following for the step a):
collect context information of the user;
relate the context information of the user to a context information of the connection to determine a numerical context value; and
merge the context values at a certain time to obtain a relation degree for the certain time.

48. The apparatus of claim 47, further comprising computer program code configured to, with the processor, cause the apparatus to perform at least the following:
weigh at least one piece of context information.

49. The apparatus of claim 47, wherein the context information comprises one or more of the following pieces: a friend list, education background, interests, posts in online platform, login logs, click logs.

50. A computer program product embodied on a non-transitory computer readable medium, comprising computer program code configured to, when executed on at least one processor, cause an apparatus or a system to:
a) determine a relation degree between a user and a connection for each user relation at a specific time;
b) list the determined relations in time order to create a time-serial relation sequence;
c) repeat steps a) and b) for all connections of the user; and
d) group the connections according to the created time serial relation sequences.

51. The computer program product of claim 50, further comprising computer program code configured to, when executed on at least one processor, cause an apparatus or a system to
display the groups to the user.

52. The computer program product of claim 50, further comprising computer program code configured to, when executed on at least one processor, cause an apparatus or a system to
group the connections with similar time serial relation sequence into a same group.

53. The computer program product of claim 50, further comprising computer program code configured to, when executed on at least one processor, cause an apparatus or a system to
transmit information to a user and to a group on the basis of the group, which information relates at least one of the following: recommendation, suggestion, promotion.
